(19) United States
(12) Patent Application Publication
(10) Pub. No.: US 2013/0214989 A1
(43) Pub. Date: Aug. 22, 2013

(54) MULTI-PLANAR ANTENNA INSERT

(71) Applicants: Richard O. Farley, San Diego, CA (US); Mark S. Caskey, San Diego, CA (US); Allen Minh-Triet Tran, San Diego, CA (US)

(72) Inventors: Richard O. Farley, San Diego, CA (US); Mark S. Caskey, San Diego, CA (US); Allen Minh-Triet Tran, San Diego, CA (US)

(73) Assignee: QUALCOMM INCORPORATED, San Diego, CA (US)

(21) Appl. No.: 13/401,279

(22) Filed: Feb. 21, 2012

(51) Int. Cl. H01Q 21/00

(52) U.S. Cl. 343/893

(57) ABSTRACT

Techniques for designing a sensor module that may be inserted into a container, for example, a box, for tracking RFID-labeled items enclosed in the container. In an exemplary embodiment, at least two planar surfaces are adjoined along a linear interface. Each of the planar surfaces supports a planar antenna whose radiation pattern may cover the volume of the container. A battery-powered tracking unit is attached to at least one of the planar surfaces to drive the planar antennas. In an exemplary embodiment, the planar antennas may be driven in succession to avoid collisions between the RFID communication signals, and for better RFID coverage of the items enclosed in the container.

### BACKGROUND

1. Field

The disclosure relates to multi-planar antenna inserts for detecting radio-frequency signals, e.g., RFID tags, in a defined volume.

2. Background

RFID (radio-frequency identification) technology allows high-value assets to be identified and tracked during distribution, shipping, delivery, etc. In one particular implementation, a tracking module may be enclosed in each box or container holding the high-value assets, and such a tracking module may identify and track RFID-labeled items in the container. The tracking unit may additionally feature support for GPS, cellular WAN connectivity, environmental sensing, an integrated RFID reader, and low power radio mesh networking technology to communicate the RFID and other information externally. The tracking unit may be designed as part of an insert, into which an antenna may be built, that is dropped into the box.

When reading the RFID-labeled contents of the box, an antenna of the tracking unit should irradiate the entire volume of the box, so that all contained items are identified. While a single antenna may serve the purpose, a non-optimized configuration of such an antenna may lead to unnecessary power consumption for the tracking module, which is battery-powered. It would be desirable to provide techniques for configuring multiple antennas to efficiently irradiate a pre-defined volume, e.g., of a box, to save power for the tracking unit.

### BRIEF DESCRIPTION OF THE DRAWINGS

FIG. 1 illustrates a tracking system according to the present disclosure.

FIG. 2 illustrates nomenclature used in the present disclosure for describing a plurality of surfaces associated with a rectangular box.

FIG. 3 illustrates an exemplary embodiment of a sensor module according to the present disclosure.

FIG. 4 shows an alternative configuration for the sensor module.

FIG. 5 shows an alternative configuration for a sensor module according to the present disclosure.

FIG. 6 illustrates an exemplary embodiment of a method according to the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The detailed description set forth below in connection with the appended drawings is intended as a description of exemplary aspects of the invention and is not intended to represent the only exemplary aspects in which the invention can be practiced. The term “exemplary” used throughout this description means “serving as an example, instance, or illustration,” and should not necessarily be construed as preferred or advantageous over other exemplary aspects. The detailed description includes specific details for the purpose of providing a thorough understanding of the exemplary aspects of the invention. It will be apparent to those skilled in the art that the exemplary aspects of the invention may be practiced without these specific details. In some instances, well-known structures and devices are shown in block diagram form in order to avoid obscuring the novelty of the exemplary aspects presented herein. In this specification and in the claims, the terms “module” and “block” may be used interchangeably to denote an entity configured to perform the operations described.

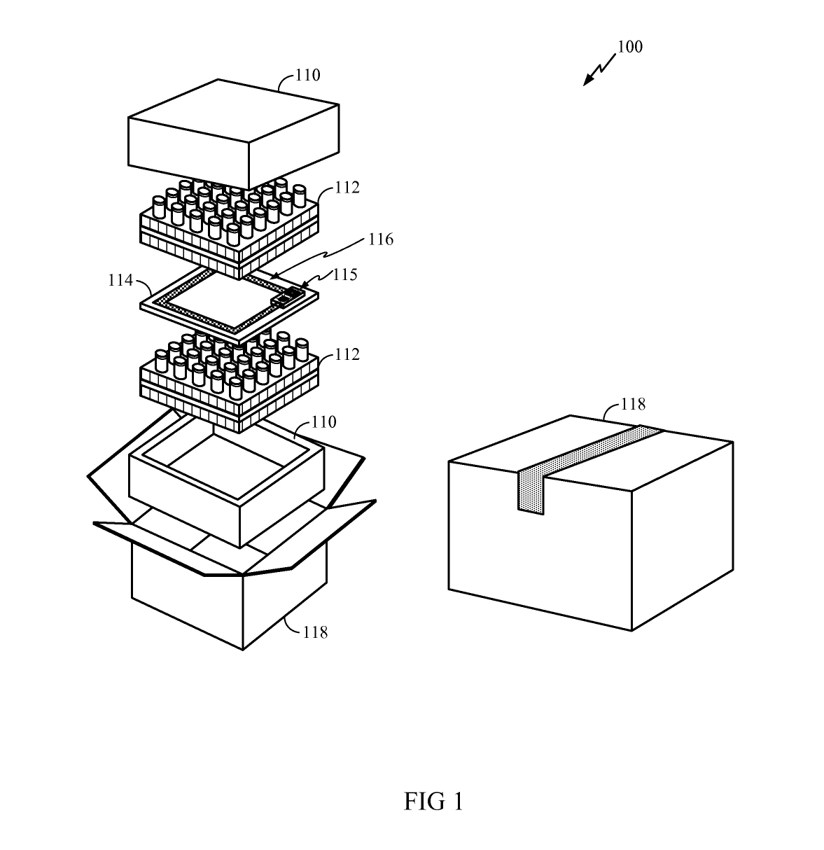

FIG. 1 illustrates a tracking system 100 according to the present disclosure. In FIG. 1, the contents of a box 118 are separately illustrated in profile. In particular, padding 110 is provided to pad the other contents of the box 118. The padding 110 may be made of, for example, Styrofoam or similar materials. Enclosed by the padding are tracked assets 112, shown in FIG. 1 as a plurality of individual bottles with RFID labels. It will be appreciated that tracked assets 112 may have any arbitrary physical shape or form, besides the bottles shown in FIG. 1.

The contents of the box 118 further include a sensor module 114, on which is provided a boundary antenna 116. The boundary antenna 116 enables the sensor module 114 to communicate with the RFID labels present on the tracked assets 112. Further coupled to the sensor module 114 is a tracking unit 115. In an exemplary embodiment, the tracking unit 115 may process the information obtained from RFID labels on the tracked assets 112, and further communicate such processed information with other external terminals (not shown), for example, using a cellular network, WLAN, Bluetooth, etc.

While the boundary antenna 116 is shown in FIG. 1 as being provided on a single planar surface of the box 118, to improve its functionality, the boundary antenna 116 may be alternately configured. In particular, the antenna should irradiate the entire box 118 to identify the presence of RFID labels therein. It would be desirable to provide multiple antennas in physical configurations such that the box 118 may be optimally covered by the antennas. For example, the sensor module 114 may include more than one planar surface, and antennas may be separately provided on such multiple planar surfaces to provide better coverage of the contents of the box 118.

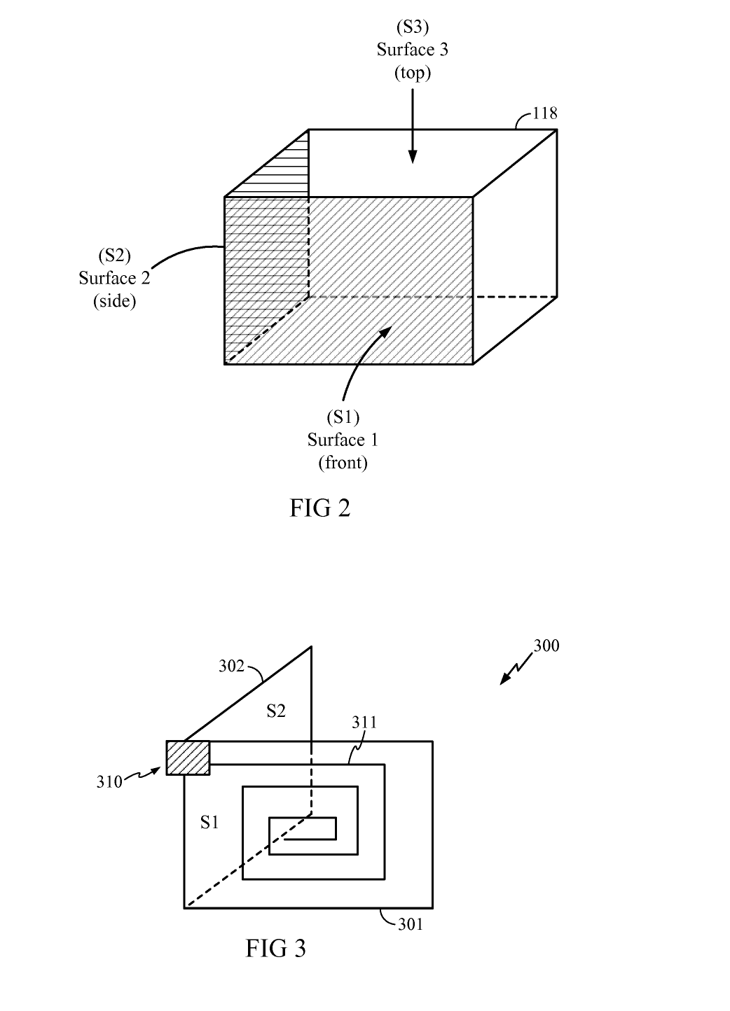

FIG. 2 illustrates nomenclature used hereinbelow for describing a plurality of surfaces associated with a rectangular box. Note FIG. 2 is not meant to restrict the scope of the present disclosure to rectangular boxes or enclosures. It will be appreciated that the techniques disclosed herein may be readily applied to any box or enclosure having non-rectangular shapes, as well as non-enclosed spaces that nevertheless have a pre-defined volume. Such alternative exemplary embodiments are contemplated to be within the scope of the present disclosure.

In FIG. 2, the front surface of the box is labeled surface one (51), while the surface directly opposite 51 (not labeled in FIG. 2) is denoted S1′. A side surface of the box is labeled surface two (S2), while the surface directly opposite S2 is denoted S2′. Finally, the top surface of the box is labeled surface three (S3), while the surface directly opposite S3 is denoted S3′. It will be clear that the denotations of surfaces as “top,” “side,” “front,” etc., are arbitrary, and may be readily interchanged according to the orientation of the box.

FIG. 3 illustrates an exemplary embodiment of a sensor module 300 according to the present disclosure. In FIG. 3, the sensor module 300 includes a first planar surface 301 and a second planar surface 302. On each of the first and second planar surfaces 301, 302 is provided a corresponding planar antenna (only one antenna 311 of which is shown in FIG. 3, corresponding to the planar surface 301).

In the exemplary embodiment shown, each planar antenna has a rectangular spiral shape. In alternative exemplary embodiments not shown, it will be appreciated that a planar antenna may take on any shape according to antenna design principles known in the art, e.g., non-rectangular spirals, single-turn antennas, etc. In an exemplary embodiment, the radiation pattern of planar antenna 311 may substantially cover the entire surface S1 of the box 118. Similarly, the radiation pattern of the planar antenna (not shown) corresponding to the surface 302 may substantially cover the entire surface S2 of the box 118. When the sensor module 118 is inserted into the box 118, it will be appreciated that the surfaces 301, 302 may lie adjacent to the inner surfaces of the box 118, and thus the planar antennas may be spatially orthogonal to each other. As the radiation patterns from the planar antennas may each substantially cover an entire surface of the box 118, the configuration of the sensor module 300 advantageously provides two independent radiation patterns for the enclosed volume of the box 118 to provide better coverage of the RFID labels contained therein.

The exemplary embodiment shown in FIG. 3 is advantageous when compared to a solution employing a single antenna for a number of reasons. In particular, using a single antenna to sufficiently irradiate the entire volume of the box may require higher power than if the box is separately irradiated by multiple antennas with differing placement, orientation, etc. There is also a greater likelihood that not all items may be read successfully when a single antenna is used due to a larger number of collisions. The aforementioned embodiment may also allow the RFID labels to be in various orientations and still be read successfully.

It will be further appreciated that first and second planar surfaces 301, 302 may also provide structural support for their corresponding planar antennas, and they may be made of insulating material such as cardboard, Styrofoam, etc. Note the physical interface between the first and second planar surfaces 301, 302 may be along a straight line, and thus may be denoted a “linear interface.” The linear interface may be flexed or otherwise bent to change the angle between the planar surfaces 301, 302, and thus the spatial relationship between the planar surfaces need not always be orthogonal. The supporting material itself may be foldable to allow the linear interface to bend, as in the case of cardboard. Alternatively, hinges or other such means may be used to connect the two planar surfaces along the linear interface.

The sensor module 300 further includes a tracking unit 310, which is coupled to the antennas 311 and 312 to process the signals transmitted and received over the antennas. The tracking unit 310 may incorporate an RFID reader (not shown) for surveying and deriving RFID information from RFID labels within the communications range of the planar antennas. Providing the two antennas as shown may advantageously improve the RFID read reliability, especially for the case in which the RFID labels may be affixed to bottles, and the bottles are in a variety of orientations

In an exemplary embodiment, the tracking unit 310 may include, e.g., a processing module (not shown) to process and integrate the information from the RFID tags and communicate such information with external devices. The tracking unit 310 may also incorporate environmental sensors (e.g., to measure temperature, light, humidity, etc), a low-power radio, GPS, cellular WAN modem, and integrated RFID reader operating at HF frequency (13.56 MHz) for item level tracking. The tracking unit 310 may further include other elements such as a portable battery (not shown) for powering the sensor module 300.

In an exemplary embodiment, each planar antenna may be radiated independently. In particular, the RFID reader may include a master controller and one or more slave controller units to drive each of the plurality of antennas (possibly more than two, as further described hereinbelow). RF switches may further be used to multiplex between the antennas.

In an exemplary embodiment, the tracking unit 310 may sequentially switch the antennas corresponding to surfaces 301, 302 on and off in succession. For example, during a first time period T1, the tracking unit 310 may enable the planar antenna 311, and simultaneously disable the planar antenna corresponding to surface 302. During T1, the planar antenna 311 is active to communicate with the RFID tags in the box 118 that are reachable by the radiation pattern of planar antenna 311. Subsequent to T1, during a second time period T2 non-overlapping with T1, the tracking unit may disable the planar antenna 311, and simultaneously enable the planar antenna corresponding to surface 302. During T2, the planar antenna corresponding to surface 302 is active to communicate with the RF ID tags in the box 118 that are responsive to the radiation pattern of that antenna. By switching the planar antennas on and off in succession as described, collisions between the signals transmitted and received by the two antennas are effectively avoided using time division multiplexing. Note in certain exemplary embodiments, these time division multiplexing techniques need not be adopted, and the multiple antennas may also be driven simultaneously for ease of control.

While time division multiplexing the signals of two antennas was described hereinabove with reference to FIG. 3, it will be appreciated that the time division multiplexing techniques may also be readily applied to accommodate more than two antennas, for example, in exemplary embodiments utilizing more than two planar surfaces as further described hereinbelow.

In an exemplary embodiment, the tracking unit 310 may further include one or more modules allowing the tracking unit 310 to communicate with other external terminals (not shown). For example, the tracking unit 310 may include a CDMA module for allowing cellular communications between the tracking unit 310 and a base station (not shown), and thereby communicate information on the contents of the box 118 collected from the RFID tags over a cellular network. The tracking unit 310 may further include modules for allowing communications over other wireless protocols such as Bluetooth, WLAN, etc. Note the information from the RFID labeled contents of the box may be read and transmitted over the WAN when exceptions occur, or on a scheduled basis.

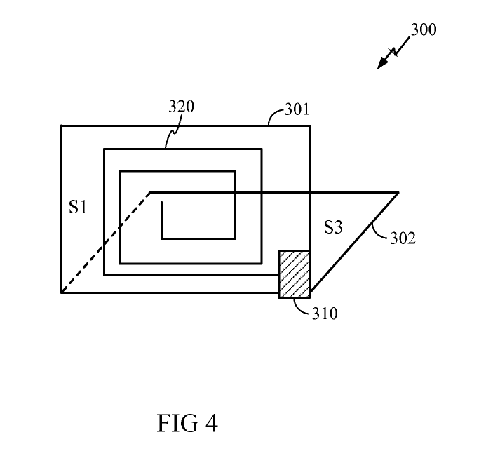

FIG. 4 shows an alternative orientation for the sensor module 300. In FIG. 4, the two planar surfaces 301, 302 are inserted into the box 118 such that the planar surface 301 is adjacent to the surface S1 of the box 118, while the planar surface 302 is adjacent to the surface S3. Note in design, the sensor modules in figures three and four may be identical, with the difference simply being in the orientation of the sensor module when placed within the box 118.

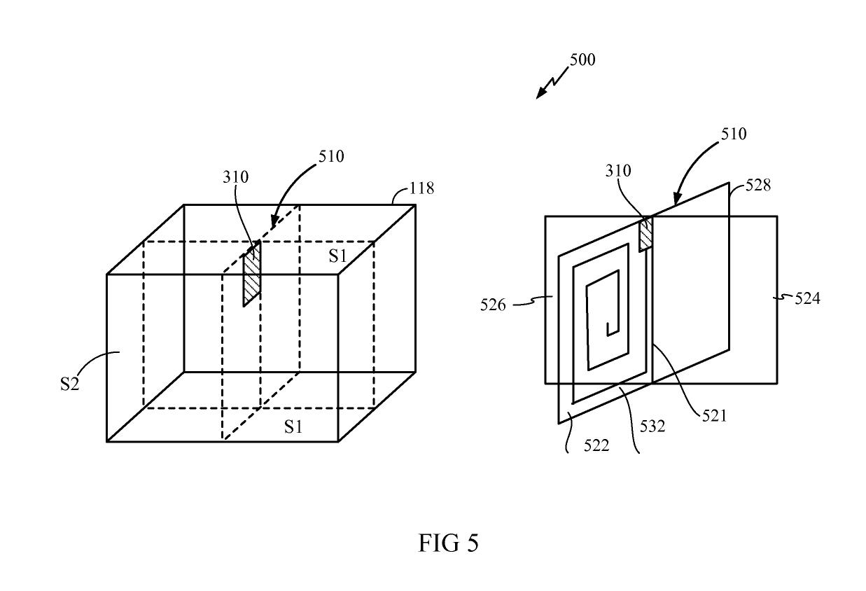

FIG. 5 shows an alternative configuration 500 for a sensor module 510 according to the present disclosure. In FIG. 5, it will be appreciated that the left diagram shows the positioning and orientation of the sensor module 510 in the box 118, while the right diagram shows the structure of the sensor module 510. According to the right diagram, the sensor module 510 includes four planar surfaces 522, 524, 526, 528. Each of the four planar surfaces supports a corresponding planar antenna (only one antenna 532 of which is shown in FIG. 5, corresponding to planar surface 522. The planar surfaces are adjoined along a linear interface 521. A tracking unit 310 is also provided on at least one of the planar surfaces, preferably in proximity to the linear interface 521. The tracking unit 310 may be coupled to and process signals for each of the four planar antennas in the sensor module 510.

In an exemplary embodiment, time division multiplexing techniques as described hereinabove may be adapted for the sensor module 510, wherein the four planar surfaces shown are each successively enabled and disabled to communicate with RFID tags in the box 118.

In light of the exemplary embodiments shown herein, it will be appreciated that alternative sensor modules (not shown) may be configured to have even more planar surfaces than shown in the figures. For example, the planar surfaces may be divided as a square, rectangular, or any other type of “grid,” e.g., a 3×3 grid. A sensor module may have multiple linear interfaces along which planar surfaces are adjoined, e.g., in the case of a 3×3 grid configuration, there may be four linear interfaces. Furthermore, planar surfaces need not be adjoined with each other at 90-degree angles upon insertion into a container. For example, in an exemplary embodiment (not shown), three planar surfaces may be adjoined at a single linear interface, and the angle between any two surfaces may be configured to be 120 degrees upon insertion into a container. Such alternative exemplary embodiments are contemplated to be within the scope the present disclosure.

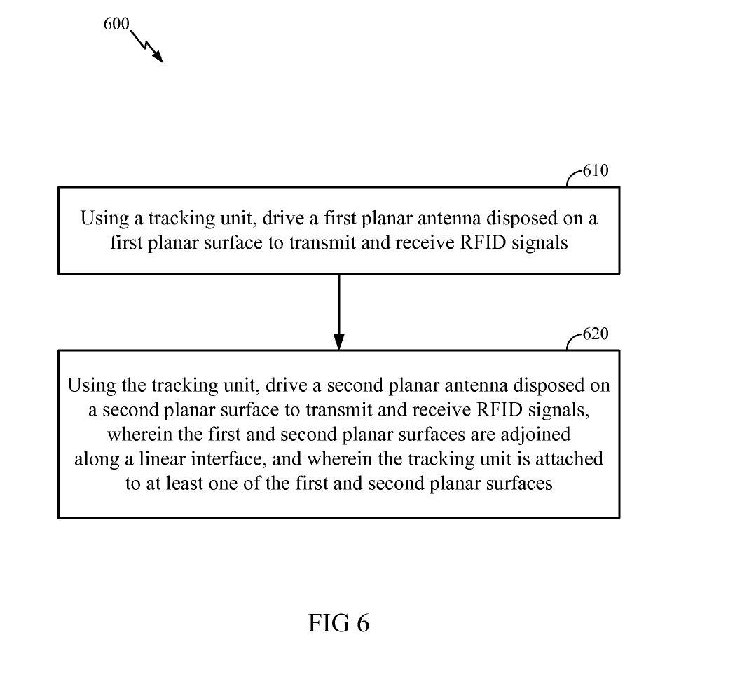

FIG. 6 illustrates an exemplary embodiment of a method 600 according to the present disclosure. Note the exemplary embodiment of FIG. 6 is shown for illustrative purposes only, and is not meant to limit the scope of the present disclosure to any particular method.

In FIG. 6, at block 610, using a tracking unit, a first planar antenna disposed on a first planar surface is driven to transmit and receive RFID signals.

At block 620, using the tracking unit, a second planar antenna disposed on a second planar surface is driven to transmit and receive RFID signals. The first and second planar surfaces are adjoined along a linear interface, and the tracking unit is attached to at least one of the first and second planar surfaces. The second planar surface is configurable to be non-coplanar with the first planar surface.

While certain exemplary embodiments are described herein for a system wherein a multi-planar antenna is configured to read RFID tags in an enclosed container, it will be appreciated that the techniques disclosed may be readily applied to other exemplary embodiments as well. For example, the multi-planar antenna insert may be configured to read wireless signals other than RFID. Furthermore, the read signals need not emanate from within a fully enclosed container, and may emanate from a container with non-enclosed surfaces, or from any arbitrary volume that may be irradiated by the antennas. Such alternative exemplary embodiments are contemplated to be within the scope of the present disclosure.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present. Furthermore, when an element is referred to as being “electrically coupled” to another element, it denotes that a path of low resistance is present between such elements, while when an element is referred to as being simply “coupled” to another element, there may or may not be a path of low resistance between such elements.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the exemplary aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary aspects of the invention.

The various illustrative logical blocks, modules, and circuits described in connection with the exemplary aspects disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary aspects disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-Ray disc where disks usually reproduce data magnetically, while discs reproduce data optically with lasers. Combinations of the above should also be included within the scope of computer-readable media.

The previous description of the disclosed exemplary aspects is provided to enable any person skilled in the art to make or use the invention. Various modifications to these exemplary aspects will be readily apparent to those skilled in the art, and the generic principles defined herein may be applied to other exemplary aspects without departing from the spirit or scope of the invention. Thus, the present disclosure is not intended to be limited to the exemplary aspects shown herein but is to be accorded the widest scope consistent with the principles and novel features disclosed herein.

1. An apparatus comprising:
a first planar surface comprising a first planar antenna;
a second planar surface, the second planar surface comprising a second planar antenna, the first and second planar surfaces adjoined along a linear interface, the second planar surface configurable to be non-coplanar with the first planar surface; and
a tracking unit attached to at least one of the first and second planar surfaces, the tracking unit configured to process wireless signals transmitted to and received from said first and second planar antennas.

2. The apparatus of claim 1, wherein the wireless signals are RFID signals.

3. The apparatus of claim 1, wherein the first and second planar surfaces are configurable to be orthogonal to each other.

4. The apparatus of claim 1, wherein the linear interface is a movable interface, and the angle between the first and second planar surfaces may be adjusted.

5. The apparatus of claim 1, the first and second planar surfaces comprising Styrofoam, cardboard, or plastic.

6. The apparatus of claim 1, the first and second planar antennas having radiation patterns substantially covering the first and second planar surfaces, respectively.

7. The apparatus of claim 1, the first and second planar surfaces adjoined at their edges.

8. The apparatus of claim 1, further comprising a third planar surface comprising a third planar antenna, and a fourth planar surface comprising a fourth planar antenna, the first, second, third, and fourth planar surfaces adjoined at a single linear interface.

9. The apparatus of claim 8, the first and third planar surfaces being coplanar, and the second and fourth planar surfaces also being coplanar.

10. The apparatus of claim 2, further comprising a container holding a plurality of RFID tags, the first and second planar surfaces fitting in the container to read the RFID tags.

11. The apparatus of claim 1, the tracking unit further configured to wirelessly communicate with a WAN.

12. The apparatus of claim 1, the tracking unit further configured to determine its location via GPS.

13. The apparatus of claim 1, the tracking unit configured to selectively enable each of the planar antennas one at a time to transmit and receive RFID signals.

14. The apparatus of claim 8, the tracking unit configured to selectively enable each of the planar antennas one at a time to transmit and receive RFID signals.

15. The apparatus of claim 1, the tracking unit further comprising at least one environmental sensor.

16. The apparatus of claim 1, the tracking unit further comprising:
a plurality of slave controller units, each slave controller configured to drive a corresponding planar antenna; and
a master controller for controlling the plurality of slave controller units.

17. The apparatus of claim 1, further comprising RF switches to multiplex between the antennas.

18. The apparatus of claim 1, each of the first and second planar antennas comprising multiple loops.

19. The apparatus of claim 1, the tracking unit further comprising a battery source sufficient to power the tracking unit.

20. A method comprising:
using a tracking unit, driving a first planar antenna disposed on a first planar surface to transmit and receive RFID signals;
using the tracking unit, driving a second planar antenna disposed on a second planar surface to transmit and receive RFID signals, wherein the first and second planar surfaces are adjoined along a linear interface, and wherein the second planar surface is configurable to be non-coplanar with the first planar surface; and
wherein the tracking unit is attached to at least one of the first and second planar surfaces.

21. The method of claim 20, wherein driving the first planar antenna is done during a first time period, and driving the second planar antenna is done during a second time period non-overlapping with the first time period.

22. The method of claim 20, further comprising, using the tracking unit, driving a third planar antenna disposed on a third planar surface to transmit and receive RFID signals, wherein the third planar surface is adjoined to at least one of the first and second planar surfaces along the linear interface.

23. An apparatus comprising:
first radiating means for communicating with RFID-labeled items enclosed in a box;
second radiating means for communicating with RFID-labeled items enclosed in the box; and
tracking means for driving the first and second radiating means.
